(19) United States
(12) Patent Application Publication
(10) Pub. No.: US 2009/0080711 A1
(43) Pub. Date: Mar. 26, 2009

(54) APPARATUS, METHOD, AND COMPUTER PROGRAM PRODUCT FOR DETECTING OBJECT FROM IMAGE

(76) Inventor: Kentaro YOKOI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/210,570

(22) Filed: Sep. 15, 2008

(30) Foreign Application Priority Data
Sep. 20, 2007 (JP) 2007-244294

(51) Int. Cl. G06K 9/62

(52) U.S. Cl. 382/116

(57) ABSTRACT

A storage unit stores therein features and reliabilities of respective first segment regions divided from a first region. An object extracting unit extracts a second region including an object from input image data. A reliability calculating unit calculates reliabilities of respective second segment regions divided from the second region. A feature calculating unit calculates features of the respective second segment regions. A similarity calculating unit calculates an object similarity by performing multiplication of: segment similarities between the features of the first segment regions divided from the first region and the features of the second segment regions; and reliabilities of the respective segment regions, and then by summing up obtained values from the multiplication. A determining unit determines that an object included in the first region matches an object included in the second region when the object similarity is greater than a threshold.

### CROSS-REFERENCE TO RELATED APPLICATIONS

This application is based upon and claims the benefit of priority from the prior Japanese Patent Application No. 2007-244294, filed on Sep. 20, 2007; the entire contents of which are incorporated herein by reference.

### BACKGROUND OF THE INVENTION

1. Field of the Invention

The present invention relates to an apparatus, a method, and a computer program that search for/extract an object corresponding to a designated object from different images, by extracting the object such as a person from images, and then by comparing features of the objects, such as colors, patterns, and shapes.

2. Description of the Related Art

There have been known methods that track or search for a specific person or object, by extracting variation regions including a moving object from a plurality of images, calculating a similarity or the like of the variation regions extracted respectively from the images, and associating the variation regions with each other.

For example, technologies that track a designated person by extracting a color region that is similar to registered color information of a designated person are disclosed in Takuro Sakiyama, Nobutaka Shimada, Jun Miura, and Yoshiaki Shirai (2003, September), Tracking designated person using color information, FIT2003 (2nd Forum on Information Technology), No. I-085, pp. 183-184 (hereinafter, “Document 1”), and in Takuro Sakiyama, Jun Miura, and Yoshiaki Shirai (2004, September), Tracking designated person based on color features, FIT2004 (3rd Forum on Information Technology), No. 1-036, pp. 79-80. JP-A 2005-202938 (KOKAI) discloses a technology that tracks/searches for a specific person, by dividing each of the variation regions extracted from a image into blocks, and then by associating the person using color information of the blocks.

A method disclosed in JP-A 2005-202938 (KOKAI), however, has a premise that the entire body of a person designated as a search object is extracted as a variation region. This poses a problem in that associating, for example, an image in which only an upper body is visible with an image in which the entire body is visible is impossible or difficult. Specifically, the problem is that when the body of a designated person is partially hidden by other persons or the like, the designated person cannot be tracked/searched for properly.

The method disclosed in Document 1 tracks and steadily updates a human region, thereby enabling search of the human region even when the body is partially hidden. However, the search is impossible when a tracking process cannot be applied, for example, when still images are compared with each other.

### SUMMARY OF THE INVENTION

According to one aspect of the present invention, an object detecting apparatus includes a storage unit configured to store image features of first segment regions divided from a first region and extraction reliabilities of the respective first segment regions. The first region is extracted, as a region including an object to be searched for, from learning image data. The apparatus also includes a receiving unit that receives input image data; an extracting unit that extracts a second region that is a candidate region including the object from the input image data; a reliability calculating unit that calculates extraction reliabilities of second segment regions divided from the second region; a feature calculating unit that calculates features of the respective second segment regions; a similarity calculating unit; and a determining unit. The similarity calculating unit calculates (1) segment similarities for respective combinations of the first segment regions and the second segment regions corresponding to the first segment regions, the segment similarities indicating similarities between the features of the first segment regions and the features of the second segment regions, (2) products of the segment similarities, the reliabilities of the first segment regions, and the reliabilities of the second segment regions, for the respective combinations, and (3) an object similarity indicating a sum of the products. The determining unit, when the object similarity is greater than a predetermined first threshold, determines that the second region includes the object.

### BRIEF DESCRIPTION OF THE DRAWINGS

FIG. 1 is a block diagram of an object detecting apparatus according to a first embodiment of the present invention;

FIG. 2 is a schematic of an exemplary structure of data stored in a storage unit;

FIG. 3 is a flowchart of a whole learning process performed by the object detecting apparatus shown in FIG. 1;

FIG. 4 illustrates an exemplary method for dividing into segment regions;

FIG. 5 illustrates an exemplary method for dividing into segment regions;

FIG. 6 is a flowchart of a whole hidden region determination process performed by the object detecting apparatus shown in FIG. 1;

FIG. 7 is a schematic for explaining a method for finding an aspect ratio of a person;

FIG. 8 illustrates exemplary combinations of a plurality of hidden regions;

FIG. 9 is a schematic for explaining a human region extraction process when no hidden region exists;

FIG. 10 is a schematic for explaining a reliability calculating process when no hidden region exists;

FIG. 11 is a schematic for explaining a feature calculating process when no hidden region exists;

FIG. 12 is a schematic for explaining the human region extraction process when a hidden region exists;

FIG. 13 is a schematic for explaining the reliability calculating process when a hidden region exists;

FIG. 14 is a schematic for explaining the feature calculating process when a hidden region exists;

FIG. 15 is a flowchart of a whole search process performed by the object detecting apparatus shown in FIG. 1;

FIG. 16 is a block diagram of an object detecting apparatus according to a second embodiment of the present invention;

FIG. 17 is a flowchart of a whole learning process performed by the object detecting apparatus shown in FIG. 16;

FIG. 18 is a flowchart of a whole search process performed by the object detecting apparatus shown in FIG. 16;

FIG. 19 is a schematic for explaining a human region extraction process when no hidden region exists;

FIG. 20 is a schematic for explaining a reliability calculating process when no hidden region exists;

FIG. 21 is a schematic for explaining a feature calculating process when no hidden region exists;

FIG. 22 is a schematic for explaining the human region extraction process when a hidden region exists;

FIG. 23 is a schematic for explaining the reliability calculating process when a hidden region exists;

FIG. 24 is a schematic for explaining the feature calculating process when a hidden region exists;

FIG. 25 is a schematic for explaining an overview of a motion capture technology; and

FIG. 26 is a schematic of a hardware structure of the object detecting apparatus shown in FIG. 1 or 16.

### DETAILED DESCRIPTION OF THE INVENTION

Exemplary embodiments of an apparatus, a method, and a computer program according to the present invention will be described in detail below with reference to the accompanying drawings. Although a person is described as a search object, the search object is not limited to a person, and can be any objects such as vehicles and animals appearing in an image.

A object detecting apparatus according to a first embodiment of the present invention detects a similar human region, by dividing an extracted human region into a predetermined number of segment regions, and then by summing up similarities (segment similarities) calculated for the respective segment regions, so as to find the sum as a similarity (object similarity) of the entire human region. By comparing an aspect ratio of the extracted human region with a reference value, determination is made as to whether a search object, i.e., a person, is partially hidden. For the hidden portion, a low extraction reliability is calculated, and the sum of the segment similarities weighted by the reliability is found as an object similarity.

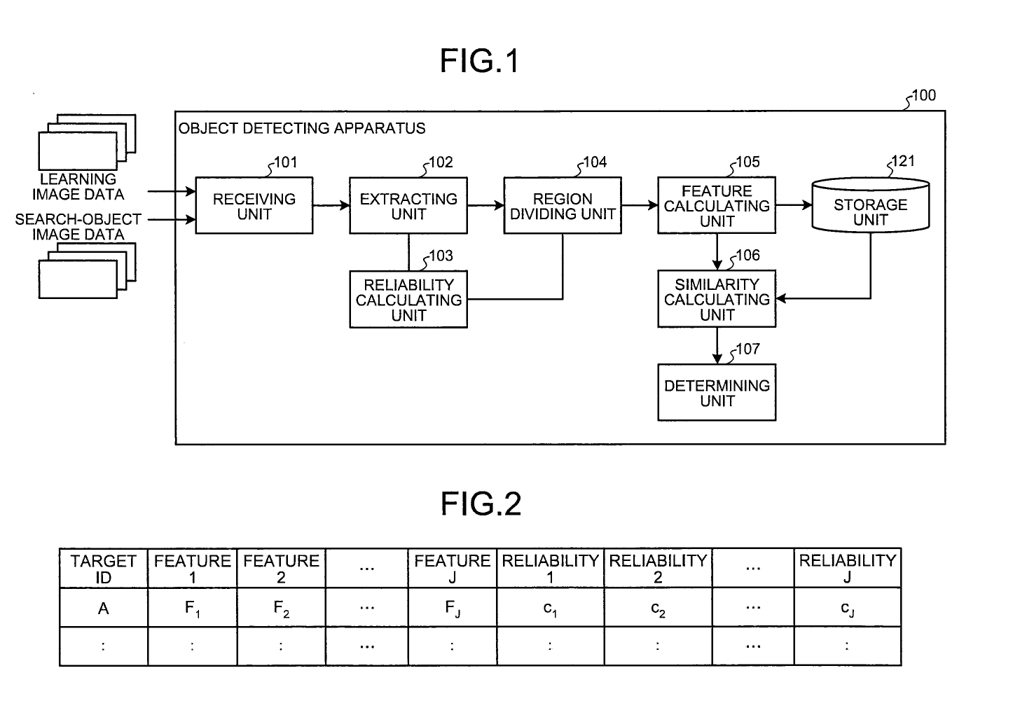

FIG. 1 is a block diagram of an object detecting apparatus 100 according to the first embodiment. As shown in FIG. 1, the object detecting apparatus 100 includes a storage unit 121, a receiving unit 101, an extracting unit 102, a reliability calculating unit 103, a region dividing unit 104, a feature calculating unit 105, a similarity calculating unit 106, and a determining unit 107.

The storage unit 121 stores therein learning image data for extracting in advance a search object to be compared, by associating the data with calculation results such as features and the like calculated by the feature calculating unit 105 (described later) or the like. FIG. 2 is a schematic of an exemplary structure of data stored in the storage unit 121. As shown in FIG. 2, the storage unit 121 stores therein data associated with: object identification (ID) for identifying a search object, i.e., a person; features 1 to J (J is a natural number of not less than 1); and reliabilities 1 to J.

The features 1 to J represent features of respective J segment regions made by dividing a human region. The reliabilities 1 to J represent reliabilities of the respective J segment regions. The j-th feature and the j-th reliability are referred to as Fⱼ and cⱼ, respectively. Methods of calculating such feature and similarity will be described later.

The storage unit 121 can be constituted by any commonly used storage medium, such as a hard disk drive (HDD), an optical disk, a memory card, or a random access memory (RAM).

The receiving unit 101 receives image data, such as moving picture data or still picture data. The receiving unit 101 may receive image data captured by, for example, a video camera (not shown), or image data retrieved from an image file stored in a memory device of the storage unit 121. Alternatively, the receiving unit 101 may receive image data supplied from an external apparatus via a network.

The extracting unit 102 extracts a human region from input image data. From images captured by a fixed camera, the extracting unit 102 extracts, as a human region, a variation region by a background subtraction method for example. For images captured by a non-fixed camera, still pictures, or video images to which background subtraction methods cannot be applied, the extracting unit 102 can use: a method for directly searching a human region by collating the human region to a person pattern; a method for extracting a human region with high accuracy by collating parts of the contour of an extraction object; or other methods.

The extracting unit 102 can use not only these methods for extracting a human region, but any methods that enable extraction of all or a portion of an object person from image data.

The reliability calculating unit 103 calculates an extraction reliability of each of the segment regions in an extracted human region. The extraction reliability represents a certainty level of extraction. When an extracted segment region is certainly a portion of a person, the reliability takes a large value, whereas when the segment region is hidden for example and therefore not being the person highly likely, the reliability takes a small value.

The reliability calculating unit 103 calculates an extraction reliability, according to an extraction method used by the extracting unit 102 for extracting a human region. For example, when using a method for extracting a human region by collating the human region to a predetermined pattern, the reliability calculating unit 103 can find a reliability by calculating a similarity between the human region and the pattern.

The reliability calculating unit 103 calculates an aspect ratio of an extracted human region and compares the aspect ratio with a predetermined reference aspect ratio, so as to estimate whether a hidden region exists. The hidden region is a region in which a human region of a designated person is hidden by other persons or the like. When estimating that a hidden region does exist, the reliability calculating unit 103 expands the human region by adding the hidden region thereto so that the aspect ratio matches a reference value.

The reliability calculating unit 103 calculates a reliability of each of the segment regions made by the region dividing unit 104 dividing a human region (described later). Specifically, the reliability calculating unit 103 allocates a reliability obtained when the entire human region is extracted to segment regions made by dividing a region other than the hidden region. Further, for segment regions made by dividing the hidden region, the reliability calculating unit 103 calculates a reliability smaller than that of the region other than the hidden region. For example, when the reliability is not less than 0 and not more than 1, the reliability calculating unit 103 calculates a reliability 0.1 for the hidden region.

The region dividing unit 104 divides an extracted human region, or a human region including an added hidden region into a plurality of segment regions. The region dividing unit 104 can divide such human region into segment regions in any shape and size. To increase collation accuracy, the region dividing unit 104 preferably divides a human region into J equal slices stacked in a vertical direction of the human region.

For an extracted human region including a hidden region added by the reliability calculating unit 103, the region dividing unit 104 may divide the region at an interface between the extracted human region and the hidden region. Alternatively, the region dividing unit 104 may divide the region into J equal pieces regardless of the position of the interface with the hidden region. In this case, for a segment region including both the extracted human region and the hidden region, the reliability calculating unit 103 calculates a reliability by weights according to ratios of the human region and the hidden region.

The feature calculating unit 105 calculates a feature of image data, such as color, pattern, or shape, for each of the divided segment regions. As a feature to be calculated, features used for related-art image search may be used, such as texture (pattern) features found by color histogram, fourier descriptor, and wavelet coefficient. To a segment region corresponding to the hidden region, the feature calculating unit 105 also applies a feature calculated using images in the above regions. Alternatively, the feature calculating unit 105 may use, as a feature of the region, a fixed value defined as an average feature for example.

The similarity calculating unit 106 calculates an object similarity, using features stored in advance in the storage unit 121 and features calculated using search object image data designated for searching for a search object. The object similarity represents a level of similarity between a human region extracted from the learning image data and a human region extracted from the search object image data.

The determining unit 107 compares a calculated object similarity with a predetermined threshold. If the object similarity is greater than the threshold, the determining unit 107 determines that a search object extracted from the learning image data matches a search object extracted from the search object image data.

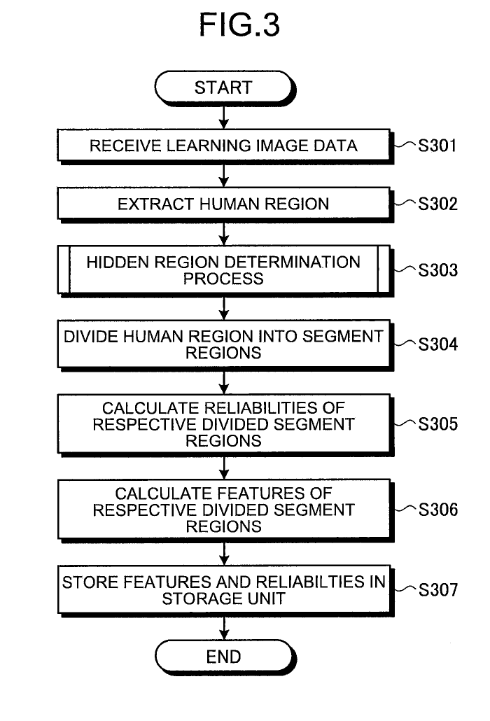

Referring to FIG. 3, the following describes a learning process performed by the object detecting apparatus 100 according to the first embodiment. The learning process includes calculating features and the like of a search object using image data input in advance, and storing in the storage unit 121 such features as information of an object to be compared for determining a matching relationship between search objects in a plurality of images. FIG. 3 is a flowchart of a whole learning process according to the first embodiment.

To begin with, the receiving unit 101 receives learning image data (Step S301). From the learning image data thus input, the extracting unit 102 extracts a human region (Step S302).

The reliability calculating unit 103 performs a hidden region determination process for determining whether a hidden region exists in a search object (Step S303). The hidden region determination process will be described in detail later.

After the hidden region determination process, the region dividing unit 104 divides the extracted human region, or the human region including the added hidden region into J segment regions (Step S304).

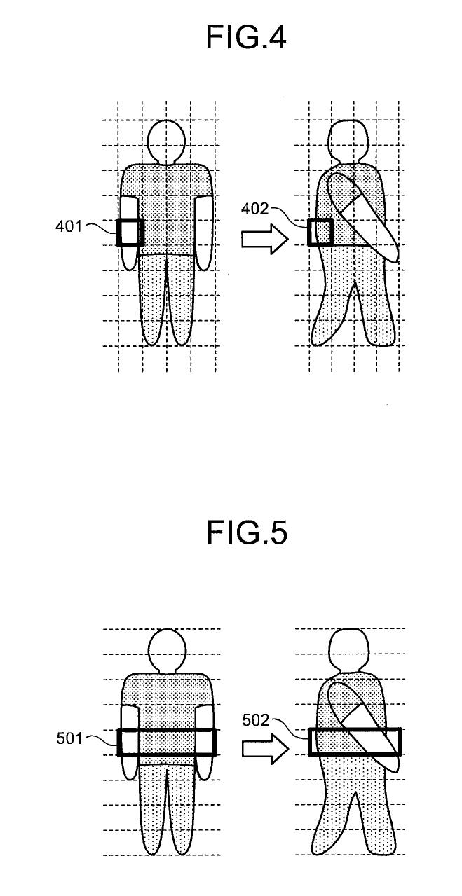

FIGS. 4 and 5 illustrate exemplary methods for dividing a human region into segment regions. FIG. 4 depicts a method for equally dividing a human region such that predetermined numbers of segments are aligned in vertical and horizontal directions, respectively. Such a dividing method poses a problem in that matching is unstable because body parts corresponding to a region vary depending on rightward and leftward movements of a person. In FIG. 4 for example, a segment region 401 before movement of the person and a segment region 402 after movement of the person correspond to different body parts of the person, i.e., the arm and the waist. Thus, when features based on color information are used for example, a difference of the features becomes large, increasing a likelihood that the regions are determined as non-corresponding regions.

On the contrary, FIG. 5 depicts a method for dividing a human region into slices stacked in the vertical direction. With such a dividing method, even when a person moves rightward and leftward, each body part remains in the same region highly likely, thus achieving stable matching. In FIG. 5 for example, a segment region 501 before movement of the person and a segment region 502 after movement of the person include the arm and the waist by almost the same ratios. Thus, even when features based on color information are used for example, a difference of the features is small, increasing a likelihood that the regions are determined as corresponding regions.

Referring back to FIG. 3, after the region dividing unit 104 divides the human region into segment regions, the reliability calculating unit 103 calculates a reliability cⱼ for each of the divided J segment regions (Step S305). Specifically, to a segment region(s) not including the hidden region, the reliability calculating unit 103 allocates a similarity obtained when the human region is extracted. On the contrary, to a segment region(s) including the hidden region, the reliability calculating unit 103 allocates a predetermined reliability (e.g., 0.1).

The feature calculating unit 105 calculates a feature Fⱼ for each of the divided J segment regions (Step S306). The feature calculating unit 105 then stores in the storage unit 121 the feature Fⱼ and the reliability cⱼ both calculated for each of the segment regions (Step S307), and ends the learning process.

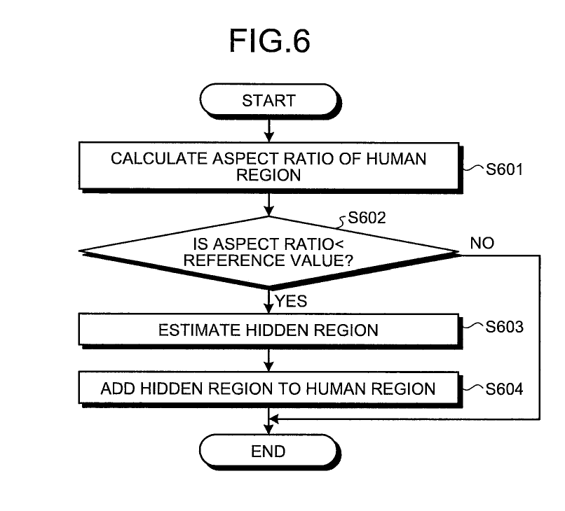

The hidden region determination process at Step S303 is described in detail. FIG. 6 is a flowchart of a whole hidden region determination process according to the first embodiment.

To begin with, the reliability calculating unit 103 calculates an aspect ratio r of an extracted human region (Step S601). The aspect ratio r is represented as r=h/w, where w is the width and h is the height of the human region.

The reliability calculating unit 103 determines whether the calculated aspect ratio r is smaller than a reference value R found in advance as an aspect ratio of an average person (Step S602).

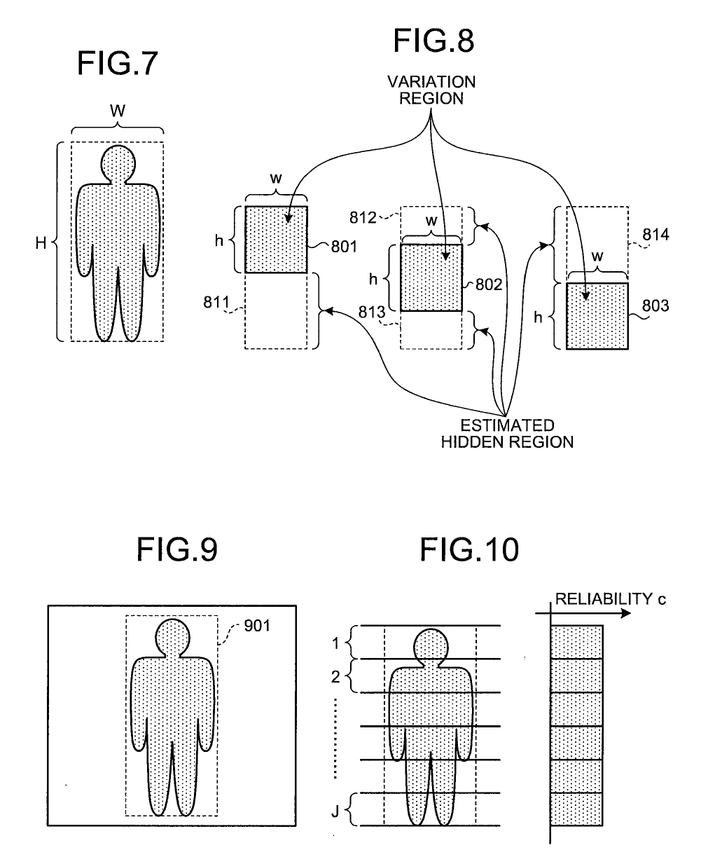

FIG. 7 is a schematic for explaining a method for finding an aspect ratio of a person. As shown in FIG. 7, provided that H=2 and W=1, where H and W are reference values of the height and the width of an average person, the reference value R of an aspect ratio can be found as R=H/W=2.

If the aspect ratio r is smaller than the reference value R (Yes at Step S602), the reliability calculating unit 103 estimates that a hidden region exists in the search object (Step S603). The reliability calculating unit 103 adds the hidden region to the extracted human region such that the aspect ratio matches the reference value (Step S604). Specifically, the reliability calculating unit 103 adds the hidden region to at least one of the upper and the lower portions of the human region, according to the ratio of the hidden region, which is calculated as (R−r)/R.

The reliability calculating unit 103 cannot determine in what ratio the hidden region exists on either the upper or the lower portion, or on both. Thus, the reliability calculating unit 103 may modify the human region by adding a plurality of hidden regions to the human region as the upper and the lower portions such that the hidden regions in combination collectively satisfy (R−r)/R.

FIG. 8 depicts exemplary combinations of hidden regions added in such a manner (i.e., the modified human region). In the left of FIG. 8 is shown a combination of a human region 801 and a hidden region 811 added to the human region 801 only as the lower portion. In the middle of FIG. 8 is shown a combination of a human region 802, and hidden regions 812 and 813 respectively added to the human region 802 as the upper and the lower portions. In the right of FIG. 8 is shown a combination of a human region 803 and a hidden region 814 added to the human region 803 only as the upper portion.

For each of the combinations as described, subsequent processes (a region dividing process, a feature calculating process, and a feature storing process) are carried out. Further, in a search process (described later), a similarity is determined using a feature and a reliability both calculated for each of the combinations, and a combination achieving the highest similarity is employed.

With regard to a height direction of a person, because the lower body is often hidden, the reliability calculating unit 103 may limit a hidden region to a region corresponding to the lower body. This enables reduction in processing load of the hidden region determination process.

The foregoing describes only an arrangement that the aspect ratio r=h/w is smaller than the reference value, i.e., a hidden region exists in the height direction. When a hidden region exists in the width direction, determination is made as to whether the aspect ratio is greater than the reference value R (=2), so that the similar hidden region estimating/adding processes may be performed.

Alternatively, by replacing the aspect ratio by r′=w/h, determination is made as to whether the aspect ratio is smaller than the reference value R′=W/H (=0.5) thus replaced accordingly, so that the similar hidden region estimating/adding processes may be performed.

Such estimation of a hidden region as shown in FIG. 6 is necessary to use, as a human region, a variation region extracted with background subtraction by the extracting unit 102. In this case, the entire human region is not necessarily extracted as the variation region. When a region is hidden by the background, such hidden region is not extracted as a variation region and therefore needs to be estimated.

On the contrary, the estimation of a hidden region as shown in FIG. 6 is not always necessary when the extracting unit 102 performs both background subtraction process and person search process. In this case, a human region is extracted by performing the person search process on a variation region extracted with the background subtraction and on the surrounding region thereof. Accordingly, within the extracted human region, a region other than the variation region can be determined as a hidden region.

When the extracting unit 102 uses only the person search process, only the human region (the whole body) and its extraction reliability are obtained. Therefore, the extraction reliability is used as a reliability of the divided segment regions made by the region dividing unit 104.

Referring to FIGS. 9 to 14, the following describes specific examples of a human region extraction process at Step S302, a reliability calculating process at Step S305, and a feature calculating process at Step S306. FIGS. 9 to 11 are drawings for explaining how those processes are performed when no hidden region exists, and FIGS. 12 to 14 are drawings for explaining how those processes are performed when a hidden region exists.

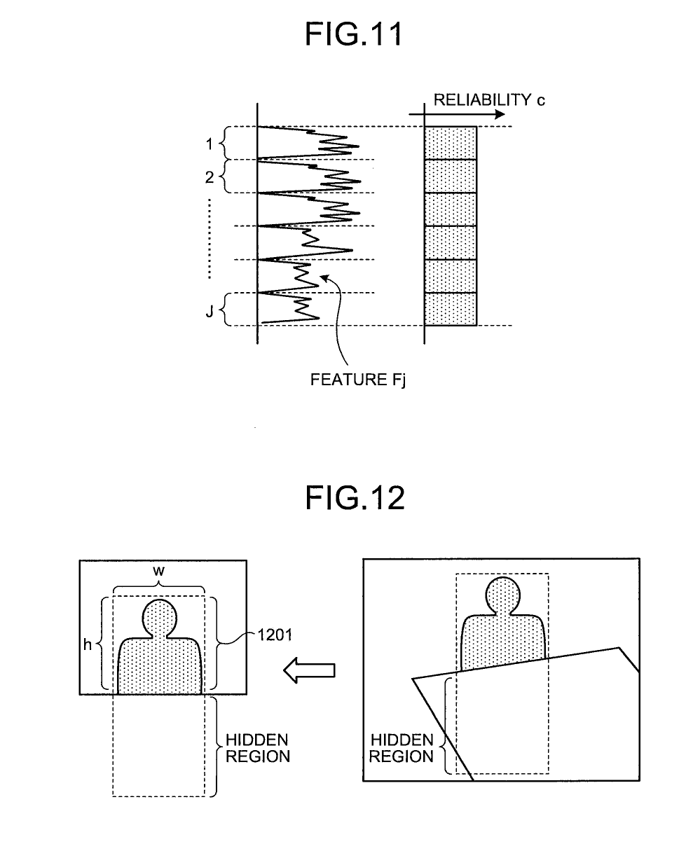

FIG. 9 depicts an example that a whole body of an object person is extracted as a human region 901 because no hidden region exists. FIG. 10 depicts an example of such human region 901 divided into sliced segment regions, with the same reliability calculated for each of the segment regions. FIG. 11 depicts features Fⱼ calculated for the respective segment regions.

On the contrary, FIG. 12 depicts an example that only an upper body of an object person is extracted as a human region 1201 because a hidden region exists, and that a portion corresponding to a lower body is estimated and added as a hidden region.

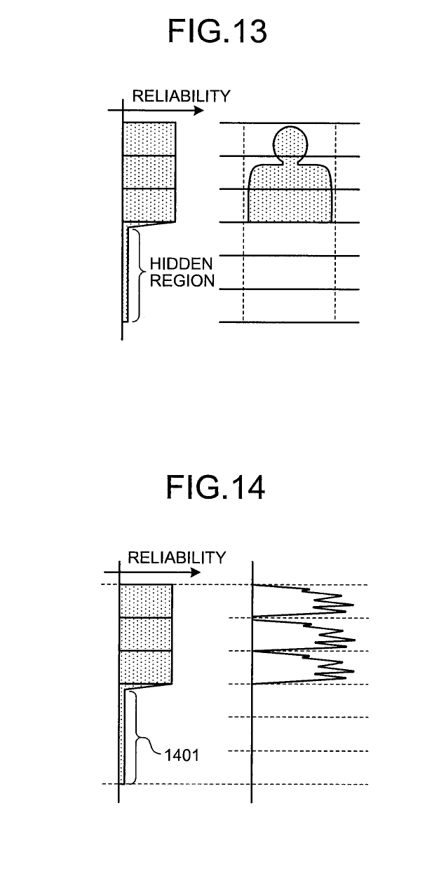

FIG. 13 depicts that a human region including an added hidden region is divided into sliced segment regions, and that a reliability is calculated for each of the segment regions. For segment region(s) corresponding to the human region 1201 first extracted, the reliability obtained at the extraction is calculated, whereas for segment region(s) corresponding to the hidden region, a low reliability is calculated.

FIG. 14 depicts that a feature Fⱼ is calculated for each of the segment regions. As described later, in the search process, a reliability is weighted to the feature Fⱼ of each of the segment regions, so that object similarities of a plurality of human regions are calculated. Thus, in the example shown in FIG. 14, the features calculated for the regions other than a hidden region 1401 are valued in calculating an object similarity.

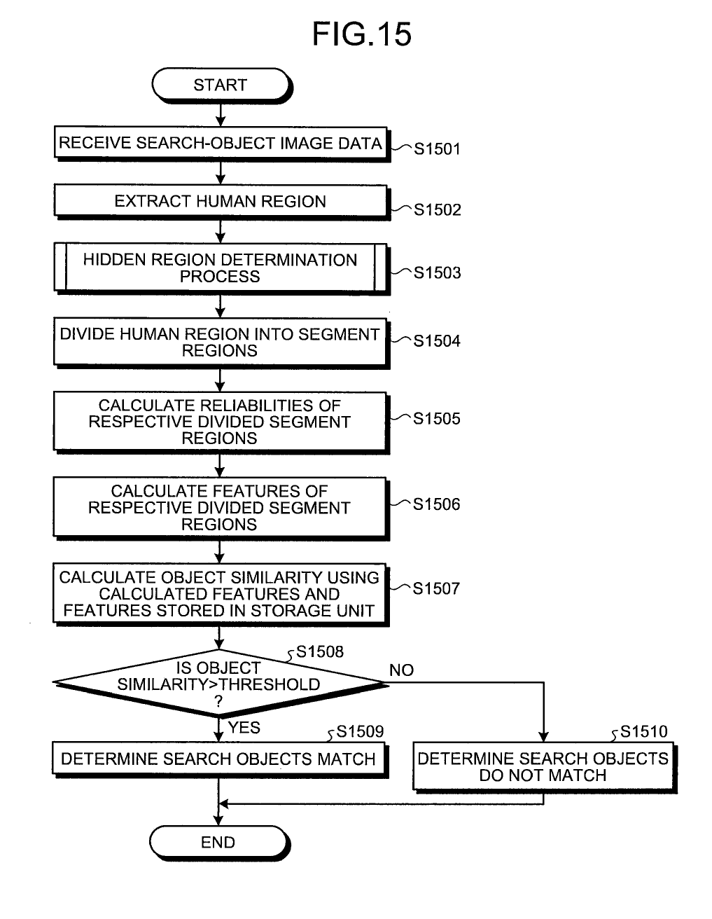

Referring to FIG. 15, the following describes a search process performed by the object detecting apparatus 100 according to the first embodiment. The search process includes searching a matching relationship between a human region extracted from input image data and a human region extracted from learning image data, using features and the like stored at the learning process and features and the like calculated with newly input image data. FIG. 15 is a flowchart of a whole search process according to the first embodiment.

To begin with, the receiving unit 101 receives search object image data (Step S1501). Subsequent steps S1502 to S1506 including human region extraction process, a hidden region determination process, a reliability calculating process, a region dividing process, and a feature calculating process are the same as those at Steps S302 to S306 in the learning process, and the descriptions thereof are not repeated.

After features of search object image data are calculated, the similarity calculating unit 106 calculates an object similarity using the features thus calculated and the features stored in the storage unit 121 (Step S1507). A specific method of calculating an object similarity is now described.

Object ID of an object to be compared is represented by i, feature is represented by F_{i,j} (j=1 to J) , and reliability is represented by c_{i,j}. Further, a feature F_{input,j} and a reliability c_{input,j} are calculated for a human region extracted from input search object image data.

The similarity calculating unit 106 calculates an object similarity S_{input,j} that is a similarity of a human region, using Equations (1) and (2):

$$\begin{matrix}{S}_{input , i} = {\sum }_{j = 1}^{J} {c}_{input , j} \times {c}_{i , j} \times similarity ( {F}_{input , j} , {F}_{i , j} ) & ( 1 ) \\ {S}_{input , i} = {\sum }_{j = 1}^{J} \frac{{c}_{input , j}}{{\sum }_{j = 1}^{J} {c}_{input , j}} \times \frac{{c}_{i , j}}{{\sum }_{j = 1}^{J} {c}_{i , j}} \times similarity ( {F}_{input , j} , {F}_{i , j} ) & ( 2 )\end{matrix}$$

Similarity (F_{input,j}, F_{i,j}) represents a segment similarity that is a similarity between a feature Fᵢₙₚᵤₜ and a feature F_{i,j}. For features represented by vectors for example, the similarity calculating unit 106 calculates, as a segment similarity, a correlation value of the feature vectors. For features represented by histogram, the similarity calculating unit 106 calculates a segment similarity by histogram intersection. As such, the similarity calculating unit 106 can use related-art methods for calculating a similarity of any features, depending on the methods for calculating features.

Equation (2) is used to calculate an object similarity S_{input,j} by normalizing the segment similarity with an overall reliability. For a partially hidden region, Equation (2) provides a more stable similarity than Equation (1).

As shown in Equations (1) and (2), a segment similarity is multiplied by reliabilities of the respective segment regions of both human regions to be compared, and obtained values for all the segment regions are summed up. In this way, an object similarity of the entire human region is calculated. Specifically, when the reliability is low, a segment similarity of corresponding segment regions is weighted less than the overall object similarity. Accordingly, for example, even when a hidden region is added, calculation of an object similarity is less affected, so that stable matching is achieved when a hidden region exists.

With the hidden region, even if such calculation can be less affected by weights, a similarity of features (a segment similarity) is lowered highly likely, causing reduction in accuracy of an overall similarity (object similarity). For example, when a person whose entire body is visible and a person whose only upper body is visible are compared, segment similarity of a portion corresponding to the hidden lower body is low. This lowers the object similarity, causing matching failure.

In this case, by evaluating a similarity based on a non-hidden portion (upper body) alone, stable matching can be achieved when a hidden region exists. For example, a similarity may be calculated using Equations (3) to (5) below:

$$\begin{matrix}{S}_{input , i} = \frac{1}{N} {\sum }_{j ∈ D} {c}_{input , j} \times {c}_{i , j} \times similarity ( {F}_{input , j} , {F}_{i , j} ) & ( 3 ) \\ N = num ( D ) & ( 4 ) \\ D = \{ d \vert min ( {c}_{input , d} , {c}_{i , d} ) \geq T \} & ( 5 )\end{matrix}$$

where min(A,B) denotes a smaller value of A and B, D is an assembly of segment regions d having reliabilities c_{input,d} and c_{j,d} that are at least equal to or greater than a threshold T, and num(D) denotes an element count of the assembly D.

By calculating an object similarity in this way, a segment region(s) having low reliabilities, such as a hidden region, are excluded from the assembly D, and not taken into account for calculation of the object similarity. This stabilizes matching when a hidden region exists.

After the object similarity is calculated using Equations (1) and (2), or (3) to (5), the determining unit 107 determines whether the object similarity is greater than a predetermined threshold (Step S1508). If the object similarity is greater than the threshold (Yes at Step S1508), the determining unit 107 determines that a person indicated by an object ID=i matches a person in the input search object image data (Step S1509).

If the object similarity is not greater than the threshold (No at Step S1508), the determining unit 107 determines that the person indicated by the object ID=i does not match the person in the input search object image data (Step S1510).

As such, in the object detecting apparatus according to the first embodiment, by comparing an aspect ratio of an extracted human region with a reference value, determination is made as to whether a search object, i.e., a person, is partially hidden. Then for the hidden portion, a low extraction reliability is calculated, and the sum of segment similarities weighted by the reliability can be found as an object similarity. Using the object similarity thus calculated, a matching relationship between human regions can be determined. Accordingly, even when the search object is partially hidden, the search object can be searched properly by collating images to each other.

An object detecting apparatus according to a second embodiment of the present invention extracts a region corresponding to a whole person (human region) by extracting regions of respective body parts, i.e., constituting elements of a person (constituting regions).

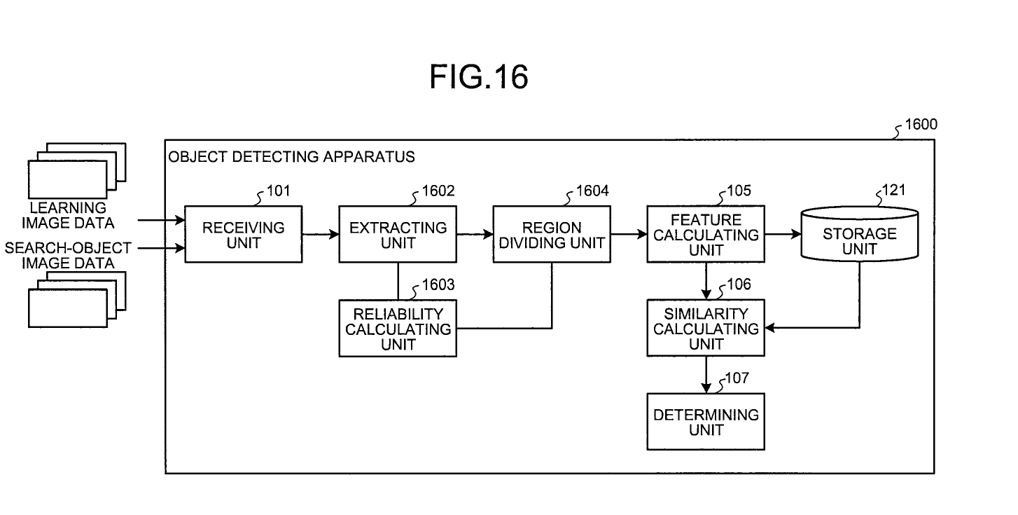

FIG. 16 is a block diagram of an object detecting apparatus 1600 according to the second embodiment. As shown in FIG. 16, the object detecting apparatus 1600 includes the storage unit 121, the receiving unit 101, an extracting unit 1602, a reliability calculating unit 1603, a region dividing unit 1604, the feature calculating unit 105, the similarity calculating unit 106, and the determining unit 107.

The second embodiment differs from the first embodiment regarding functions of the extracting unit 1602, the reliability calculating unit 1603, and the region dividing unit 1604. Other structures and functions are the same as those of the object detecting apparatus 100 according to the first embodiment, shown in the block diagram of FIG. 1. Thus, the same reference numerals are used and the descriptions thereof are omitted.

The extracting unit 1602 extracts constituting regions that correspond to respective body parts of a person, from input image data. For example, the extracting unit 1602 extracts each of the constituting elements that correspond to nine body parts: head, left shoulder, right shoulder, chest, left arm, right arm, abdomen, left leg, and right leg. As an extraction method, any related-art methods may be used, such as a method for extracting a constituting element by comparing each body part with its collation pattern.

The reliability calculating unit 1603 calculates a reliability of each segment region that is an extracted constituting region. The reliability calculating unit 1603 calculates, for example, a similarity between each body part and its collation pattern, as a reliability of each segment region. When the region dividing unit 1604 (described later) subdivides each constituting region, the reliability calculating unit 1603 calculates a reliability of each division unit serving as a segment region. In this case, the reliability calculating unit 1603 may calculate a similarity between a constituting region before subdivided and the collation pattern, as a reliability of each segment region after subdivided.

The region dividing unit 1604 divides an extracted human region into a plurality of segment regions. Most simply, the region dividing unit 1604 divides the human region into segment regions that correspond to constituting regions extracted for respective body parts. Alternatively, the region dividing unit 1604 may divide the human region into segment regions made by subdividing each constituting region.

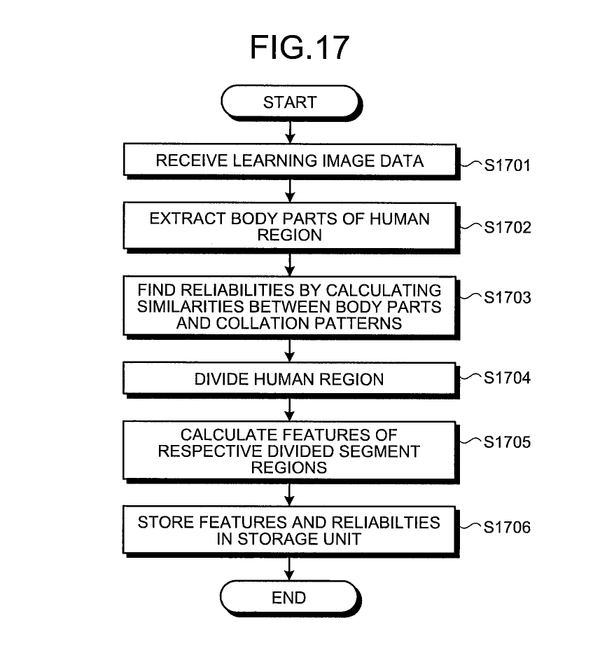

Referring to FIG. 17, the following describes a learning process performed by the object detecting apparatus 1600 according to the second embodiment. FIG. 17 is a flowchart of a whole learning process according to the second embodiment.

To begin with, the receiving unit 101 receives an input of learning image data (Step S1701). The extracting unit 1602 extracts a human region, by extracting each body part one by one, from the learning image data thus input (Step S1702). Specifically, by extracting each constituting element corresponding to each body part of a person, the extracting unit 1602 extracts a human region including such constituting regions.

The reliability calculating unit 1603 calculates a similarity between a constituting region and a collation pattern, as a reliability of each body part (Step S1703). Then, the region dividing unit 1604 divides the human region into segment regions (Step S1704). As described, the region dividing unit 1604 divides the human region into segment regions in units of constituting elements, or divides the human region into segment regions so as to subdivide each constituting region. When the region dividing unit 1604 subdivides each constituting region, the reliability calculating unit 1603 allocates, to subdivided segment regions, a reliability of a corresponding constituting region before subdivided.

The feature calculating process and the feature storing process at Steps S1705 to S1706 are the same as those at Steps S306 to S307 performed by the object detecting apparatus 100 according to the first embodiment, and the descriptions thereof are not repeated.

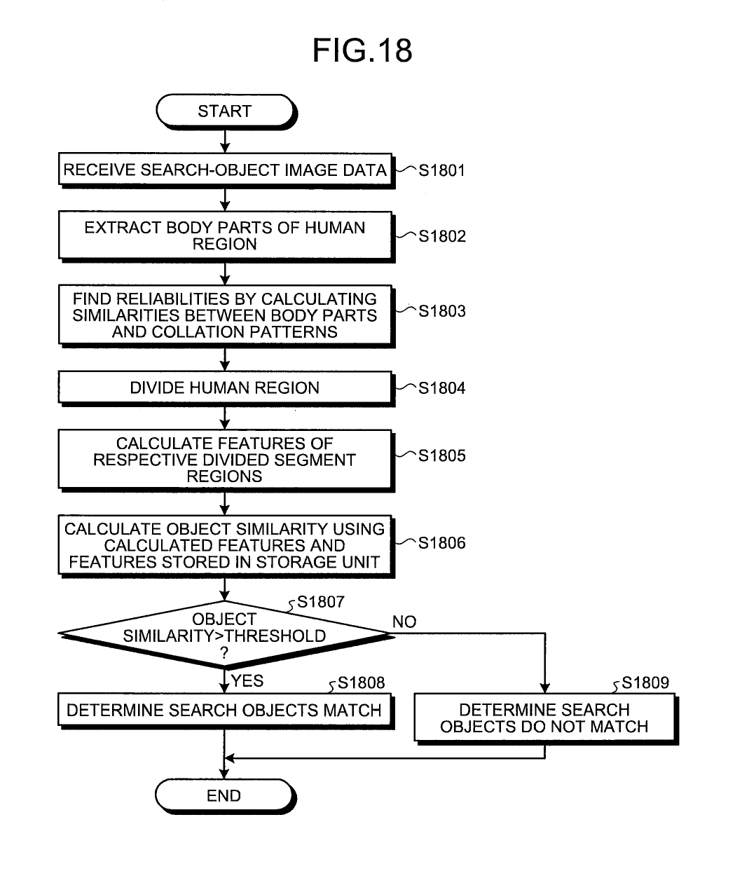

Referring to FIG. 18, the following describes a search process performed by the object detecting apparatus 1600 according to the second embodiment. FIG. 18 is a flowchart of a whole search process according to the second embodiment.

A image data input process, a human region extraction process, a reliability calculating process, and a region dividing process at Steps S1801 to S1804 are the same as those at Steps S1701 to S1704 of the learning process shown in FIG. 17, and the descriptions thereof are not repeated.

Further, a feature calculating process and a matching determination process at Steps S1805 to S1809 are the same as those at Steps S1506 to S1510 performed by the object detecting apparatus 100 according to the first embodiment, and the descriptions thereof are not repeated.

As such, according to the second embodiment, a matching relationship between search objects can be determined using the same methods used in the first embodiment, except a method for extracting a human region.

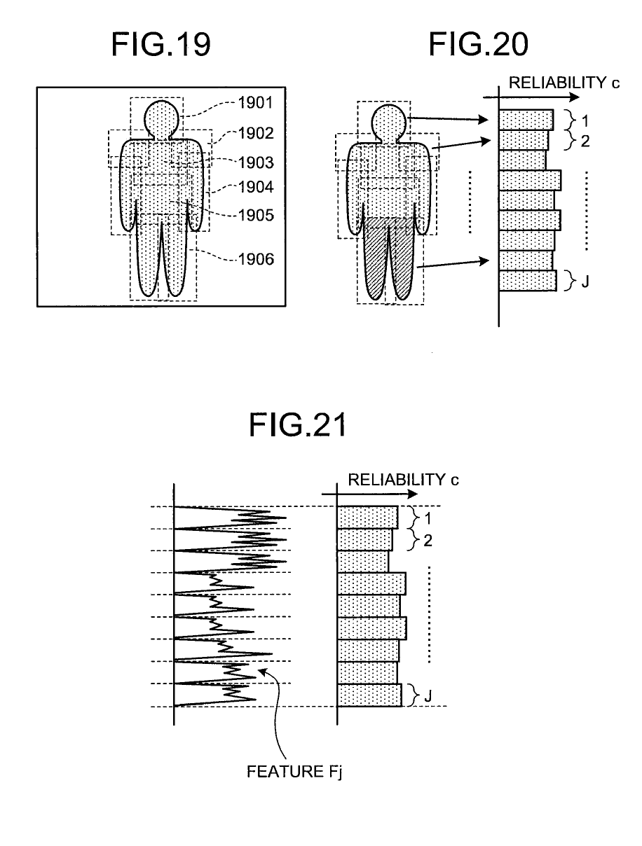

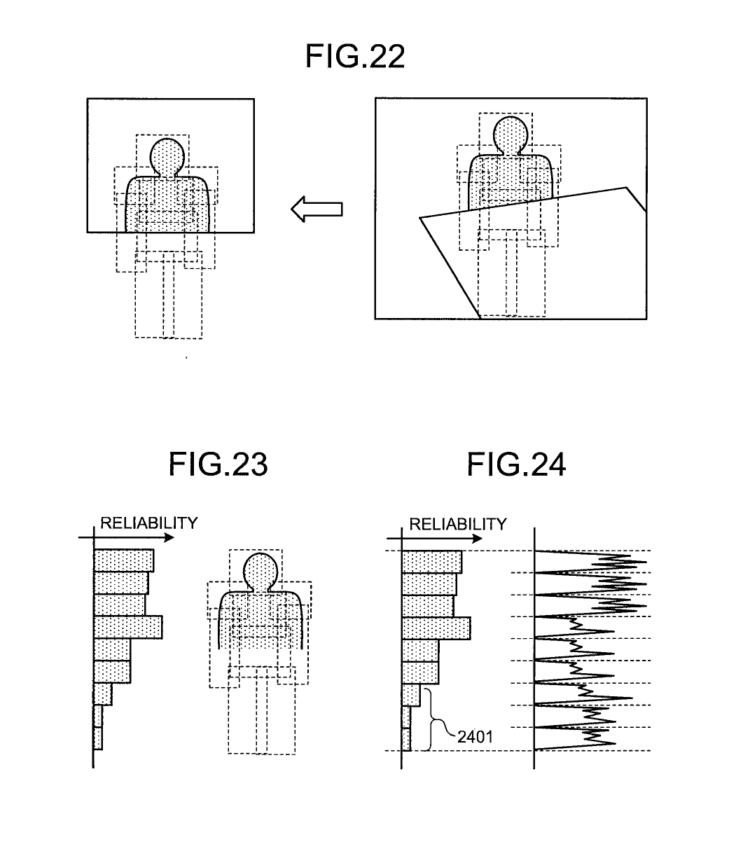

Referring to FIGS. 19 to 24, the following describes specific examples of the human region extraction process, the reliability calculating process, and the feature calculating process according to the second embodiment. FIGS. 19 to 21 are drawings for explaining the processes when no hidden region exits, whereas FIGS. 22 to 24 are drawing for explaining processes when a hidden region exists.

FIG. 19 depicts that an object person is entirely extracted because no hidden region exits, also showing constituting regions extracted for respective body parts: a head constituting region 1901, a left shoulder constituting region 1902, a chest constituting region 1903, a left arm constituting region 1904, an abdomen constituting region 1905, and a left leg constituting region 1906.

FIG. 20 depicts reliabilities calculated for respective segment regions each serving as such constituting region. In general, different reliabilities are calculated for the segment regions.

FIG. 21 depicts that features Fⱼ are calculated for the respective segment regions.

On the contrary, FIG. 22 depicts an example that segment regions are extracted for respective body parts when a hidden region exits. Even when the hidden region exists in the lower body as shown in FIG. 22, the extracting unit 1602 extracts constituting regions corresponding to all body parts.

FIG. 23 depicts reliabilities calculated for respective segment regions each serving as such constituting region. Because a hidden region exists in the lower body as shown in FIG. 23, reliabilities smaller than those of the other segment regions are calculated for segment regions corresponding to the lower body.

FIG. 24 depicts that features Fⱼ are calculated for the respective segment regions. In the example shown in FIG. 24, features calculated for a segment region 2401 corresponding to the lower body are not valued in calculating an object similarity, due to low reliabilities. Accordingly, stable matching is achieved even when a hidden region exits.

As such, the object detecting apparatus according to the second embodiment can use the same search process as in the first embodiment, even using a method for extracting a region of each body part constituting a person. Accordingly, even when a search object is partially hidden, the search object can be searched properly by collating images to each other.

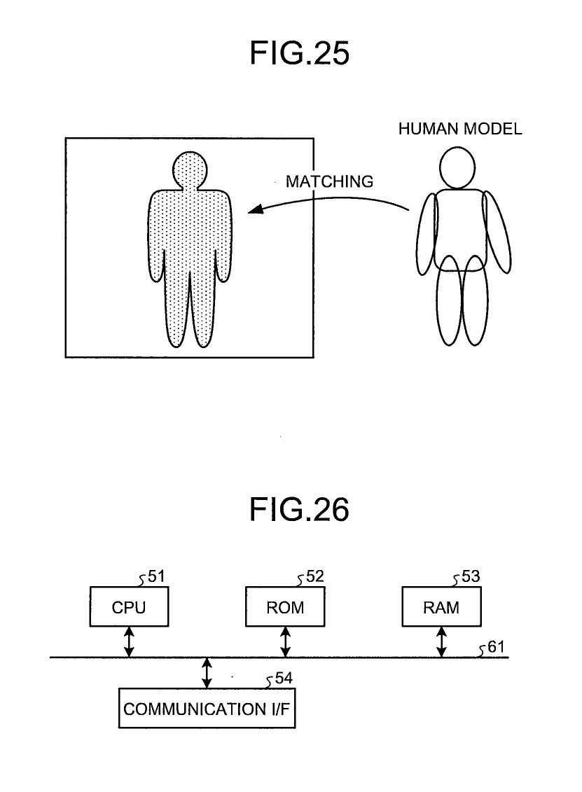

As an alternative method for extracting a region of each body part, motion capture technology may be applied. FIG. 25 is a schematic for explaining a motion capture technology. As shown in FIG. 25, the motion capture technology performs matching with a human model of a whole body including body part models.

Specifically, the extracting unit 1602 extracts a region of each body part by performing matching with the human model, using edge information and silhouette information of an image. The reliability calculating unit 1603 calculates, as a reliability of each segment region, a matching score with respect to each body part model, obtained as a result of the matching with the human model. The region dividing unit 1604 divides the human region into body parts, according to the matching with the human model.

Referring to FIG. 26, the following describes a hardware structure of the object detecting apparatus according to the first or the second embodiment. FIG. 26 is a schematic of a hardware structure of an object detecting apparatus according to the first or the second embodiment.

The object detecting apparatus according to the first or the second embodiment includes: a controlling device such as a central processing unit (CPU) 51; a memory device such as a read only memory (ROM) 52 or a RAM 53; a communication interface (I/F) 54 that performs communication connecting to a network; an external memory device such as a hard disk drive (HDD) or a compact disc (CD) drive device; a displaying device such as a display; an input device such as a keyboard or a mouse; and a bus 61 that connects these units. The object detecting apparatus has a hardware structure using a general computer.

An object search computer program implemented by the object detecting apparatus according to the first or the second embodiment is provided as being written in installable or executable file format, and recorded in a computer-readable medium, such as a compact disk read only memory (CD-ROM), a flexible disk (FD), a compact disk recordable (CD-R), a digital versatile disk (DVD) or a memory. The computer readable medium which stores an object search computer program will be provided as a computer program product.

Alternatively, the object search computer program implemented by the object detecting apparatus according to the first or the second embodiment may be provided as being stored in a computer connected to a network such as the Internet and downloaded via the network. Further, the object search computer program implemented by a object detecting apparatus according to the first or the second embodiment may be provided or distributed via a network such as the Internet.

Further, the object search computer program according to the first or the second embodiment may be provided as being installed in advance in a ROM or the like.

The object search computer program implemented by a object detecting apparatus according to the first or the second embodiment is configured as a module including the above-described units (the vide input unit, the extracting unit, the reliability calculating unit, the region dividing unit, the feature calculating unit, the similarity calculating unit, and the determining unit). Further, to realize hardware, the object search computer program is read out from the storage medium and implemented by the CPU 51 (processor), so that the above units are loaded and generated in a main memory device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object detecting apparatus comprising:
a storage unit configured to store image features of first segment regions divided from a first region and extraction reliabilities of the respective first segment regions, the first region being extracted, as a region including an object to be searched for, from learning image data;
a receiving unit configured to receive input image data;
an extracting unit configured to extract a second region that is a candidate region including the object from the input image data;
a reliability calculating unit configured to calculate extraction reliabilities of second segment regions divided from the second region;
a feature calculating unit configured to calculate features of the respective second segment regions;
a similarity calculating unit configured to calculate
(1) segment similarities for respective combinations of the first segment regions and the second segment regions corresponding to the first segment regions, the segment similarities indicating similarities between the features of the first segment regions and the features of the second segment regions,
(2) products of the segment similarities, the reliabilities of the first segment regions, and the reliabilities of the second segment regions, for the respective combinations, and
(3) an object similarity indicating a sum of the products; and
a determining unit configured to, when the object similarity is greater than a predetermined first threshold, determine that the second region includes the object.

2. The apparatus according to claim 1, wherein
the reliability calculating unit calculates an aspect ratio representing a ratio of a height of the second region to a width of the second region,
the reliability calculating unit modifies, when the aspect ratio is smaller than a predetermined reference value, the second region to add a region as at least one of upper and lower portions of the second region such that the aspect ratio of the modified second region is substantially equal to the reference value, and calculates extraction reliabilities of the second segment regions divided from the modified second region, the extraction reliabilities of the second segment regions of the added region being smaller than those of the second segment regions of the original second region, and
the feature calculating unit calculates features of the respective second segment regions of the modified second region.

3. The apparatus according to claim 1, wherein
the reliability calculating unit calculates an aspect ratio representing a ratio of a height of the second region to a width of the second region,
the reliability calculating unit modifies, when the aspect ratio is smaller than a predetermined reference value, the second region to
add regions as upper and lower portions of the second region by changing height ratio of the upper and lower portions such that the aspect ratio of the modified second region is substantially equal to the reference value,
the reliability calculating unit calculates, for each of the modified second regions, extraction reliabilities of second segment regions divided from the modified second region, the extraction reliabilities of the second segment regions of the added regions being smaller than those of the second segment regions of the original second region,
the feature calculating unit calculates features of the respective second segment regions of the modified second regions,
the similarity calculating unit calculates object similarities for the features calculated, and
the determining unit determines, when the highest object similarity is greater than the first threshold, determines that the second region includes the object.

4. The apparatus according to claim 1, wherein
the reliability calculating unit calculates an aspect ratio representing a ratio of a height of the second region to a width of the second region,
the reliability calculating unit modifies, when the aspect ratio is greater than a predetermined reference value, the second region to add a region as at least one of left and right portions of the second region such that the aspect ratio of the modified second region is substantially equal to the reference value, and calculates extraction reliabilities of the second segment regions divided from the modified second region, the extraction reliabilities of the second segment regions of the added region being smaller than those of the second segment regions of the original second region, and
the feature calculating unit calculates features of the respective second segment regions of the modified second region.

5. The apparatus according to claim 1, wherein
the reliability calculating unit calculates an aspect ratio representing a ratio of a height of the second region to a width of the second region,
the reliability calculating unit modifies, when the aspect ratio is greater than a predetermined reference value, the second region to add regions as left and right portions of the second region by changing width ratio of the left and right portions such that the aspect ratio of the modified second region is substantially equal to the reference value,
the reliability calculating unit calculates, for each of the modified second regions, extraction reliabilities of second segment regions divided from the modified second region, the extraction reliabilities of the second segment regions of the added regions being smaller than those of the second segment regions of the original second region,
the feature calculating unit calculates features of the respective second segment regions of the modified second regions,
the similarity calculating unit calculates object similarities for the features calculated, and
the determining unit determines, when the highest object similarity is greater than the first threshold, determines that the second region includes the object.

6. The apparatus according to claim 1, wherein
the reliability calculating unit calculates an aspect ratio representing a ratio of a height of the second region to a width of the second region,
the reliability calculating unit modifies, when the aspect ratio is smaller than a predetermined reference value, the second region to add a region as at least one of upper and lower portions of the second region such that the aspect ratio of the modified second region is substantially equal to the reference value, and calculates extraction reliabilities of the second segment regions divided from the modified second region, the extraction reliabilities of the second segment regions of the added region being smaller than those of the second segment regions of the original second region, and
the feature calculating unit calculates features of the respective second segment regions of the modified second region.

7. The apparatus according to claim 1, wherein
the extracting unit extracts, for respective constituting elements of the object, a plurality of constituting regions respectively including the constituting elements from the input image data, so as to extract the second region including the constituting regions extracted, and
the reliability calculating unit calculates the reliabilities of the respective second segment regions serving as the constituting regions, or of the respective second segment regions into each constituting region is divided.

8. The apparatus according to claim 1, wherein, from among the combinations, the similarity calculating unit calculates
(1) the product for some combinations of the first segment regions and the second segment regions corresponding to the first segment regions, both the first and the second regions having reliabilities being greater than a predetermined second threshold, and
(2) the object similarity indicating the sum of the products.

9. The apparatus according to claim 1, wherein
the storage unit stores therein the features of the respective first segment regions divided from the first region with horizontal dividing lines, and the reliabilities of the respective first segment regions, and
the reliability calculating unit calculates the reliabilities of the respective second segment regions divided from the second region with horizontal dividing lines.

10. An object detecting method for an object detecting apparatus for detecting an object to be searched for, the object detecting apparatus including a storage unit configured to store image features of first segment regions divided from a first region and extraction reliabilities of the respective first segment regions, the first region being extracted, as a region including the object, from learning image data, the object detecting method comprising:
receiving input image data;
extracting a second region that is a candidate region including the object from the input image data;
calculating extraction reliabilities of second segment regions divided from the second region;
calculating features of the respective second segment regions;
calculating segment similarities for respective combinations of the first segment regions and the second segment regions corresponding to the first segment regions, the segment similarities indicating similarities between the features of the first segment regions and the features of the second segment regions;
calculating products of the segment similarities, the reliabilities of the first segment regions, and the reliabilities of the second segment regions, for the respective combinations;
calculating an object similarity indicating a sum of the products; and
determining, when the object similarity is greater than a predetermined first threshold, determines that the second region includes the object.

11. A computer program product having a computer readable medium including programmed instructions for detecting an object to be searched for using a computer, the computer including a storage unit configured to store image features of first segment regions divided from a first region and extraction reliabilities of the respective first segment regions, the first region being extracted, as a region including the object, from learning image data, wherein the instructions, when executed by the computer, cause the computer to perform:
receiving input image data;
extracting a second region that is a candidate region including the object from the input image data;
calculating extraction reliabilities of second segment regions into which the second region is divided;
calculating features of the respective second segment regions;
calculating segment similarities for respective combinations of the first segment regions and the second segment regions corresponding to the first segment regions, the segment similarities indicating similarities between the features of the first segment regions and the features of the second segment regions;
calculating products of the segment similarities, the reliabilities of the first segment regions, and the reliabilities of the second segment regions, for the respective combinations;
calculating an object similarity indicating a sum of the products; and
determining, when the object similarity is greater than a predetermined first threshold, determines that the second region includes the object.
